(19) United States
(12) Patent Application Publication
(10) Pub. No.: US 2026/0357144 A1
(43) Pub. Date: Nov. 12, 2026

(54) MICROWAVE GASIFICATION SYSTEM FOR LARGE-PARTICLE-SIZE BIOMASS, BIOCHAR, AND APPLICATION OF BIOCHAR

(71) Applicant: Xi'an Jiaotong University, Xi'an (CN)

(72) Inventors: Lei Deng, Xi'an (CN); Jiyun Ren, Xi'an (CN); Jiahao Jiang, Xi'an (CN); Xiaole Huang, Xi'an (CN); Chizhong Wang, Xi'an (CN); Yunhao Shao, Xi'an (CN); Fuzhe Lei, Xi'an (CN); Hong An, Xi'an (CN); Defu Che, Xi'an (CN)

(21) Appl. No.: 19/555,969

(22) Filed: Mar. 4, 2026

(30) Foreign Application Priority Data
May 7, 2025 (CN) 2025105833895

(51) Int. Cl. C10J 3/30; B01D 53/14; B01D 53/18; B01J 20/20; B01J 20/30; B01J 21/18; B01J 37/10; B01J 37/34; B09C 1/08; C10J 3/00; C10J 3/24; C10J 3/72; C10J 3/84; C10K 1/00; C10K 1/16; C10K 1/22

(52) U.S. Cl. CPC C10J 3/30; B01D 53/1493; B01D 53/18; B01J 20/20; B01J 20/3078; B01J 21/18; B01J 37/10; B01J 37/346; C10J 3/002; C10J 3/24; C10J 3/723; C10J 3/84; C10K 1/002; C10K 1/16; C10K 1/22; B01D 2252/202; B01D 2256/16; B01D 2256/20; B09C 1/08; C10J 2200/15; C10J 2300/092; C10J 2300/123; C10J 2300/1618

(57) ABSTRACT

A microwave gasification system for large-particle-size biomass, a biochar, and an application of the biochar are provided, which belong to the field of renewable energy utilization technologies. The microwave gasification system includes a microwave gasification device, an oxygen supply device, a nitrogen supply device, a water vapor supply device, a biochar collection device, a tar collection device, a syngas purifier, and a syngas collection device. The microwave gasification system can effectively achieve the preparation of a large-particle-size biochar. Furthermore, by integrating microwave gasification technology, X-ray computed tomography, and a software reconstruction method, natural characteristics of a biomass feedstock and high efficiency of microwave heating are fully utilized to enable in-depth research on the pore structure and mineral characteristics of the large-particle-size biochar, thereby providing support for optimizing the application of the large-particle-size biochar.

### CROSS-REFERENCE TO RELATED APPLICATION

This application claims priority to Chinese Patent Application No. 202510583389.5, filed on May 7, 2025, which is herein incorporated by reference in its entirety.

### TECHNICAL FIELD

The disclosure relates to the field of renewable energy utilization technologies, and more particularly to a microwave gasification system for large-particle-size biomass, a biochar, and an application of the biochar.

### BACKGROUND

Biochar, as an emerging carbon material, is widely applied in fields such as soil improvement, water treatment, and environmental remediation due to its excellent adsorption properties and environmentally friendly characteristics. The biochar is typically produced from biomass through processes including pyrolysis, drying, and gasification at a high temperature ranging from 600 °C to 900 °C.

Conventionally, biomass feedstock used for gasification is in powdered form, which requires a fine crushing and processing procedure. This increases energy consumption and directly raises production costs. However, unlike coal powder, biomass materials cannot be economically processed into fine particles, particularly fibrous biomass. Typically, biomass feedstock used for commercial purposes has a relatively larger particle size. Large-particle-size biomass is generally easy to obtain and can directly utilize agricultural and forestry waste, reducing the demand for small-particle-size biomass feedstock and thereby improving an overall utilization rate of the biomass. In some regions, the collection and transportation of the large-particle-size biomass are relatively convenient, lowering costs and resource waste. Gasification of the large-particle-size biomass can improve gasification efficiency by optimizing reaction conditions such as temperature and pressure, often resulting in higher gasification yield and gas quality. Larger particles can facilitate proper airflow and heat exchange during gasification, making the pyrolysis and gasification of the biomass more efficient. Therefore, directly using the large-particle-size biomass for gasification can save energy consumption and produce higher-quality biochar and syngas.

At present, the biochar is primarily produced through an electric heating method, which relies mainly on conduction/convection to transfer energy to a material and raise its temperature. However, this method inevitably creates a temperature gradient, resulting in external overheating and insufficient internal heating. Due to the significant heat and mass transfer resistance encountered during gasification of the large-particle-size biomass, traditional electric heating means are unable to effectively heat and gasify the interior of the large-particle-size biomass.

### SUMMARY

To solve the above technical problems, the disclosure provides a microwave gasification system for large-particle-size biomass, a biochar, and an application of the biochar. Microwave heating is essentially a dielectric heating method, which directly supplies energy to a sample through ionic conduction and dipole rotation, accomplishing a non-contact conversion of electromagnetic energy into thermal energy during this process. Biomass microwave gasification technology utilizes microwave irradiation heating to convert a biomass material into a gaseous fuel primarily composed of syngas. The microwave irradiation acts directly on the biomass material in the form of electromagnetic waves, causing vibration of internal water and organic molecules of the biomass material, thereby rapidly raising the temperature. Conventionally, microwave systems used for preparing biochar employ pyrolysis methods, resulting in the biochar with underdeveloped pore structures, relatively high tar yields, and lower syngas purity, which constrain its application efficiency. Traditional microwave fixed-bed gasification is designed for micron-sized biomass particles and has high energy consumption.

In the microwave gasification of a biomass feedstock according to the disclosure, a particle size of the biomass feedstock can be extended to the centimeter scale. There is no need to crush the biomass feedstock into millimeter-scale or even micron-scale small particles, thereby reducing the energy consumption and cost associated with pulverization. By utilizing water vapor combined with oxygen for the microwave gasification, the microwave heating directly penetrates large-particle-size biomass through the action of an internal electromagnetic field, causing its interior to rapidly heat up. This avoids the heat transfer losses inherent in traditional external heating methods, resulting in higher overall thermal efficiency. Furthermore, an oxygen-water vapor mixture as a gasification agent promotes carbon oxidation-reduction reactions, increases the yield of hydrogen (H₂) and carbon monoxide (CO) in the syngas, and generates more syngas. Combined with the oxygen-water vapor gasification environment, high-temperature microwave pyrolysis effectively cracks tar, and after further tar removal, the syngas becomes purer. The biochar produced by the microwave gasification is a by-product of gasification. It possesses a developed pore structure, a relatively large specific surface area, and abundant surface functional groups, and its resource utilization can thus be effectively addressed.

In a first aspect, the disclosure provides a microwave gasification system for large-particle-size biomass, which is implemented through the following technical solutions. The microwave gasification system of the disclosure includes a microwave gasification device, an oxygen supply device, a nitrogen supply device, a water vapor supply device, a biochar collection device, a tar collection device, a syngas purifier, and a syngas collection device.

The microwave gasification device is configured to perform microwave gasification treatment on a large-particle-size biomass feedstock to form a large-particle-size biochar. A particle size of the large-particle-size biomass feedstock is centimeter-scale, for example, the particle size of the large-particle-size biomass feedstock is in a range of 1 centimeter (cm) to 9.9 cm.

An output end of the oxygen supply device is connected to an input end of the microwave gasification device, and the oxygen supply device is configured to supply oxygen for the microwave gasification treatment in the microwave gasification device.

An output end of the nitrogen supply device is connected to the input end of the microwave gasification device, and the nitrogen supply device is configured to supply nitrogen as a protective gas for the microwave gasification treatment in the microwave gasification device.

An output end of the water vapor supply device is connected the input end of the microwave gasification device, and the water vapor supply device is configured to provide a gas motive force for conveying the large-particle-size biomass feedstock to a reaction zone of the microwave gasification device.

An input end of the biochar collection device is connected to a solid output end of the microwave gasification device, and the biochar collection device is configured to collect the large-particle-size biochar produced by the microwave gasification treatment in the microwave gasification device.

An input end of the tar collection device is connected to a gas output end of the microwave gasification device, and the tar collection device is configured to receive gas generated from the microwave gasification treatment in the microwave gasification device and perform pretreatment on the gas to remove tar from the gas, thereby obtaining tar-removed gas.

An input end of the syngas purifier is connected to a gas output end of the tar collection device, and the syngas purifier is configured to remove impurities and moisture from the tar-removed gas to form purified syngas.

An input end of the syngas collection device is connected to a gas output end of the syngas purifier, and the syngas collection device is configured to collect the purified syngas for combustion utilization.

In some specific embodiments of the disclosure, the microwave gasification device includes a microwave gasification furnace, a microwave generator, a temperature-power controller, a quartz tube, a quartz basket, and a microwave thermocouple.

The microwave generator is disposed in the microwave gasification furnace and configured to provide microwave irradiation.

The temperature-power controller is electrically connected to the microwave generator and configured to control a reaction temperature and a power of the microwave irradiation provided by the microwave generator.

The quartz tube is horizontally disposed in the microwave gasification furnace and configured to define the reaction zone for the microwave gasification treatment in the microwave gasification device.

The quartz basket is disposed in the quartz tube and configured to hold the large-particle-size biomass feedstock.

The microwave thermocouple is horizontally disposed in the quartz tube and configured to monitor in real time a temperature of a microwave gasification reaction in the microwave gasification furnace.

In some specific embodiments of the disclosure, a first pressure-reducing valve is disposed between the output end of the oxygen supply device and the input end of the microwave gasification device, and the first pressure-reducing valve is configured to reduce a pressure of the oxygen.

A second pressure-reducing valve is disposed between the nitrogen supply device and the input end of the microwave gasification device, and the second pressure-reducing valve is configured to reduce a pressure of the nitrogen.

A first mass flow meter is disposed between an output end of the first pressure reducing valve and the input end of the microwave gasification device, and the first mass flow meter is configured to monitor a flow rate of the oxygen.

A second mass flow meter is disposed between an output end of the second pressure reducing valve and the input end of the microwave gasification device, and the second mass flow meter is configured to monitor a flow rate of the nitrogen.

In some specific embodiments of the disclosure, the water vapor supply device includes a water supply device and a heat tracing tape.

An output end of the water supply device is connected to the input end of the microwave gasification device through a delivery pipe to supply water.

The heat tracing tape is wound around the delivery pipe and configured to heat the water in the delivery pipe to form water vapor serving as the gas motive force and entering the microwave gasification device. Specifically, a temperature of the heat tracing tape may be set in a range of 140 °C to 160 °C to ensure that the water in the delivery pipe can be heated to generate the water vapor.

In some specific embodiments of the disclosure, the tar collection device is a gas scrubber containing isopropanol, and configured to remove the tar from the gas generated from the microwave gasification treatment in the microwave gasification device. Specifically, the tar collection device consists of six gas washing bottles filled with the isopropanol, and the six gas washing bottles are located in an ice-water bath for collecting the tar generated from the microwave gasification treatment in the microwave gasification device.

In some specific embodiments of the disclosure, the syngas purifier is packed with desiccant silica gel particles.

In a second aspect, the disclosure provides a biochar, which is prepared by the microwave gasification treatment using the above microwave gasification system for large-particle-size biomass. That's to say, the biochar is the large-particle-size biochar.

In a third aspect, the disclosure provides an application of the biochar in preparation of a soil amendment material, a pollutant adsorption material, a catalytic tar cracking material, or an environmental remediation material, which includes:
determining a porosity of the biochar; and
selecting, based on the porosity of the biochar, a specific application for the biochar.

The porosity of the biochar is determined by:
obtaining, by using X-ray computed tomography, microstructural images of the above biochar to form grayscale images at different angles;
performing preprocessing on the grayscale images at the different angles by using an advanced 3D analysis software (Avizo™ software) to improve clarity and identifiability of the grayscale images, thereby obtaining multiple preprocessed images;
performing identification and threshold segmentation on the multiple preprocessed images by using the Avizo™ software to obtain multiple threshold-segmented images;
combining the multiple threshold-segmented images to obtain a three-dimensional reconstruction model of the biochar; and
performing porosity analysis on the three-dimensional reconstruction model of the biochar to obtain the porosity of the biochar.

In some specific embodiments of the disclosure, the preprocessing includes image screening, image type conversion, volume editing, image denoising, and contrast enhancement.

The identification is performed by:
distinguishing, based on brightness in each of the multiple preprocessed images, a pore region and a mineral region, where a region with a brightness between a brightness of the pore region and a brightness of the mineral region is a matrix region, thereby obtaining the pore region, the matrix region, and the mineral region of the biochar.

In some specific embodiments of the disclosure, the threshold segmentation is performed by:
performing the threshold segmentation on the pore region of the biochar based on a first threshold range to obtain a segmented pore region of a slice of the biochar, where the first threshold range is 0 to 2500;
performing the threshold segmentation on the mineral region of the biochar based on a second threshold range to obtain a segmented mineral region of the slice of the biomass, where the second threshold range is 10,000 to 30,000; and
performing threshold segmentation on the matrix region of the biochar based on a third threshold range to obtain a segmented matrix region of the slice of the biochar, where the third threshold range is 2501 to 9999.

The disclosure aims to directly utilize the large-particle-size biomass for microwave gasification, and then employs the Avizo™ software to perform three-dimensional reconstruction of the large-particle-size biochar. By fully leveraging natural characteristics of the biomass feedstock and high efficiency of microwave heating, pore structure and mineral characteristics of the large-particle-size biochar are studied. This approach offers multiple advantages, including reduced application cost, improved efficiency, and enhanced stability of the gasification process.

Compared with the related art, the disclosure may achieve the following beneficial effects.

The microwave gasification system for large-particle-size biomass of the disclosure includes the microwave gasification device, the oxygen supply device, the nitrogen supply device, the water vapor supply device, the biochar collection device, the tar collection device, the syngas purifier, and the syngas collection device. The microwave gasification system of the disclosure is capable of directly and efficiently heating large-particle-size biomass, and can produce high-quality syngas, low-yield tar, and large-particle-size biochar with a rich pore structure.

The disclosure proposes the microwave gasification system for large-particle-size biomass and a three-dimensional reconstruction method for biochar. This method integrates microwave gasification technology, X-ray computed tomography, and a software reconstruction method. It aims to fully utilize the natural characteristics of biomass feedstock and the high efficiency of microwave heating to obtain the large-particle-size biochar. By applying the three-dimensional reconstruction method to the large-particle-size biochar, an in-depth study of its pore structure and mineral characteristics is conducted, thereby providing support for optimizing the application of the large-particle-size biochar.

The disclosure provides the microwave gasification system for large-particle-size biomass and the three-dimensional reconstruction method for biochar. The method includes the microwave gasification system for large-particle-size biomass, identification of the large-particle-size biochar by using the computed tomography, and the software reconstruction method for the large-particle-size biochar by using the Avizo™ software. The microwave gasification system for large-particle-size biomass is coupled with the identification of the large-particle-size biochar by using the computed tomography, and the identification of the large-particle-size biochar by using the computed tomography is integrated with the software reconstruction method for the large-particle-size biochar by using the Avizo™ software. Through the accurate identification and analysis of the pore structure of the large-particle-size biochar, important foundational data is provided for optimizing the preparation and application of biochar, which can enhance its effectiveness in environmental remediation and wastewater treatment.

### BRIEF DESCRIPTION OF DRAWINGS

FIG. 1 illustrates a schematic structural diagram of a microwave gasification system for large-particle-size biomass according to the disclosure.

FIG. 2 illustrates a schematic diagram of X-ray computed tomography scanning equipment and its scanning process according to the disclosure.

FIG. 3 illustrates a schematic diagram of a three-dimensional reconstruction image and grayscale cross-section images of a first biochar according to the disclosure. Specifically, (a) is the three-dimensional reconstruction image of the first biochar, (b) is a two-dimensional grayscale cross-section image of the first biochar in an x-y direction, and (c) is a two-dimensional grayscale cross-section image of the first biochar in an x-z direction.

FIG. 4 illustrates a schematic diagram of a three-dimensional reconstruction image and grayscale cross-section images of a second biochar according to the disclosure. Specifically, (a) is the three-dimensional reconstruction image of the second biochar, (b) is a two-dimensional grayscale cross-section image of the second biochar in an x-y direction, and (c) is a two-dimensional grayscale cross-section image of the second biochar in an x-z direction.

FIG. 5 illustrates a schematic diagram of a three-dimensional reconstruction image and grayscale cross-section images of a third biochar according to the disclosure. Specifically, (a) is the three-dimensional reconstruction image of the third biochar, (b) is a two-dimensional grayscale cross-section image of the third biochar in an x-y direction, and (c) is a two-dimensional grayscale cross-section image of the third biochar in an x-z direction.

FIG. 6 illustrates a schematic diagram of layer-by-layer porosity of three large-particle-size biochars according to the disclosure.

### DESCRIPTION OF REFERENCE SIGNS

1—oxygen supply device; 2—nitrogen supply device; 3—first pressure-reducing valve; 4—second pressure-reducing valve; 5—first mass flow meter; 6—second mass flow meter; 7—first three-way valve; 8—injection pump; 9—second three-way valve; 10—heat tracing tape; 11—microwave thermocouple; 12—microwave generator; 13—temperature-power controller; 14—quartz tube; 15—quartz basket; 16—large-particle-size biomass feedstock; 17—biochar collection tank; 18—large-particle-size biochar; 19—tar collection device; 20—isopropanol; 21—dyngas purifier; 22—syngas storage bag; 23—X-ray emitter; 24—sample rotation stage; 25—X-ray detector; 26—computer; 27—microwave gasification furnace; 28—delivery pipe.

### DETAILED DESCRIPTION OF EMBODIMENTS

Technical solutions in embodiments of the disclosure will be clearly and completely described below.

As described in the “BACKGROUND” section, biochar is currently primarily produced through electrically heated pyrolysis methods, with powdered biomass traditionally used as feedstock for gasification. The microwave gasification technology for large-particle-size biomass offers multiple advantages, including cost reduction, efficiency improvement, and enhanced stability of a gasification process. It enables the production of large-particle-size biochar with well-developed pore structures and high-quality syngas. Traditional analytical methods often fail to comprehensively and accurately characterize the microstructure of biochar. In light of this, the disclosure proposes an innovative approach that integrates microwave gasification for large-particle-size biomass, computer tomography for identifying large-particle-size biochar, and reconstruction using an advanced 3D analysis software (an Avizo™ software). This aims to achieve three-dimensional visualization of the pore structure and minerals in biochar, providing theoretical support for optimizing its applications.

### Embodiment 1

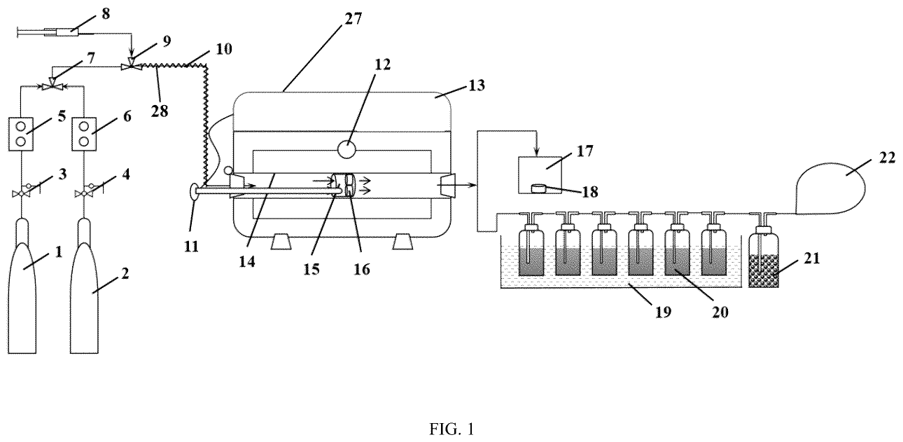

The disclosure provides a microwave gasification system for large-particle-size biomass. As shown in FIG. 1, the microwave gasification system for large-particle-size biomass of this embodiment includes a microwave gasification device, an oxygen supply device 1, a nitrogen supply device 2, a water vapor supply device, a biochar collection device, a tar collection device 19, a syngas purifier 21, and a syngas collection device.

The microwave gasification device is configured to perform microwave gasification treatment on a large-particle-size biomass feedstock 16 to form a large-particle-size biochar 18. The microwave gasification device is a microwave gasification furnace 27. A microwave generator 12 is disposed in the microwave gasification furnace 27 and configure to provide microwave irradiation. The microwave generator 12 is electrically connected to a temperature-power controller 13 and disposed surrounding a quartz tube 14. The quartz tube 14 is horizontally disposed in the microwave gasification furnace 27 and configured to provide a reaction zone for the microwave gasification treatment in the microwave gasification device. The large-particle-size biomass feedstock 16 is placed in a quartz basket 15, and then the quartz basket 15 is placed in the quartz tube 14.

A microwave thermocouple 11, whose detection end is located at a surface of the large-particle-size biomass feedstock 16, is horizontally disposed in the quartz tube 14.

During the microwave gasification treatment of the large-particle-size biomass feedstock 16, the large-particle-size biomass feedstock 16 is first placed in the quartz basket 15, and then the quartz basket 15 is placed in the quartz tube 14. The temperature-power controller 13 is configured to control the microwave generator 12 to provide a reaction temperature and a reaction power for the microwave gasification treatment during an experiment. During a heating period, a temperature of a microwave gasification reaction in the microwave gasification furnace 27 is monitored in real time by the microwave thermocouple 11, and the microwave gasification treatment is performed on the large-particle-size biomass feedstock 16. During the microwave gasification treatment, oxygen is supplied only during the microwave gasification reaction, while nitrogen is supplied throughout an entire process of the microwave gasification treatment.

During supply of the oxygen, the oxygen enters the microwave gasification device through an output end of the oxygen supply device 1, providing the oxygen for the microwave gasification treatment in the microwave gasification device. Furthermore, a first pressure-reducing valve 3 and a first mass flow meter 5 are disposed between the output end of the oxygen supply device 1 and an input end of the microwave gasification device. According to requirements of the experiment, the first pressure-reducing valve 3 is configured to reduce a pressure of the oxygen entering the first mass flow meter 5. The first mass flow meter 5 is configured to monitor a magnitude of a flow rate of the oxygen, thereby controlling the flow rate of the oxygen entering the microwave gasification furnace 27.

During supply of the nitrogen, the nitrogen enters the microwave gasification device through an output end of the nitrogen supply device 2, providing the nitrogen as a protective gas for the microwave gasification treatment in the microwave gasification device. A second pressure-reducing valve 4 and a second mass flow meter 6 are disposed between the output end of the nitrogen supply device 2 and the input end of the microwave gasification device. According to the requirements of the experiment, the second pressure-reducing valve 4 is configured to reduce a pressure of the nitrogen entering the second mass flow meter 6. The second mass flow meter 6 is configured to monitor a magnitude of a flow rate of the nitrogen, thereby controlling the flow rate of the nitrogen entering the microwave gasification furnace 27.

The nitrogen and the oxygen are combined through a first three-way valve 7 to form a mixed gas path, which is then connected to the water vapor supply device. The water vapor supply device is configured to deliver water to the microwave gasification device through a delivery pipe 28. Specifically, the water vapor supply device includes a water supply device and a heat tracing tape 10. In this embodiment, the water supply device is an injection pump 8. The mixed gas path is merged with the water flowing from the injection pump 8 through a second three-way valve 9. The second three-way valve 9 is connected to the delivery pipe 28, and the heat tracing tape 10 is wound around the delivery pipe 28. When the microwave gasification furnace 27 reaches the reaction temperature, the heat tracing tape 10 is activated to heat the delivery pipe 28. The heat tracing tape 10 is set to a temperature of 150 °C, which heats the water in the delivery pipe 28 to form water vapor serving as a gas motive force and entering the microwave gasification device.

When the microwave gasification furnace 27 reaches a preset reaction temperature, the water vapor supply device and the oxygen supply device 1 are activated, and the large-particle-size biomass feedstock 16 is introduced into the reaction zone of the microwave gasification furnace 27 for microwave reaction. The microwave generator 12 heats the large-particle-size biomass feedstock 16 to carry out a rapid gasification reaction, thereby obtaining a gas mixture and the large-particle-size biochar 18.

The microwave gasification furnace 27 is connected to an inlet of a biochar collection tank 17 and an inlet of the tar collection device 19. The tar collection device 19 is connected to an inlet of the syngas purifier 21. The syngas purifier 21 is connected to an inlet of a syngas storage bag 22.

The large-particle-size biochar 18 generated from the microwave gasification treatment passes through a solid output end of the microwave gasification device and an input end of the biochar collection device, and then enters the biochar collection device. The biochar collection device used in the disclosure is the biochar collection tank 17.

The gas mixture generated from the microwave gasification treatment passes through a gas output end of the microwave gasification device and an input end of the tar collection device 19, and then enters the tar collection device 19. In the tar collection device 19, the gas mixture is cooled by an ice-water mixture, and liquid tar from the gas mixture is adsorbed by using isopropanol 20 for pretreatment, thereby removing tar from the gas mixture to obtain a first gas (i.e., tar-removed gas). The obtained first gas passes through a gas output end of the tar collection device 19 and an input end of the syngas purifier 21, and then enters the syngas purifier 21. In the syngas purifier 21, gas washing bottles filled with silica gel particles are used for adsorption and drying to remove impurities and moisture from the first gas, yielding purified syngas. The purified syngas passes through a gas output end of the syngas purifier 21 and an input end of the syngas collection device, and then enters the syngas collection device for collection and subsequent combustion. The syngas collection device used in the disclosure is the syngas storage bag 22.

Through the effective operation of the above system, a large-particle-size biochar 18 with a relatively large specific surface area and a favorable porous structure can be generated, providing a good sample for subsequent image processing.

### Embodiment 2

This embodiment provides a three-dimensional reconstruction method for biochar, which includes the following steps 1 to 4.

In step 1, the large-particle-size biomass feedstock 16 is subjected to the microwave gasification treatment by using the microwave gasification system of the embodiment 1, thereby obtaining the large-particle-size biochar 18.

In step 2, internal structural images (i.e., microstructural images) of the large-particle-size biochar 18 is obtained by using X-ray computed tomography, thereby forming multiple grayscale images at different angles, which includes the following specific operations.

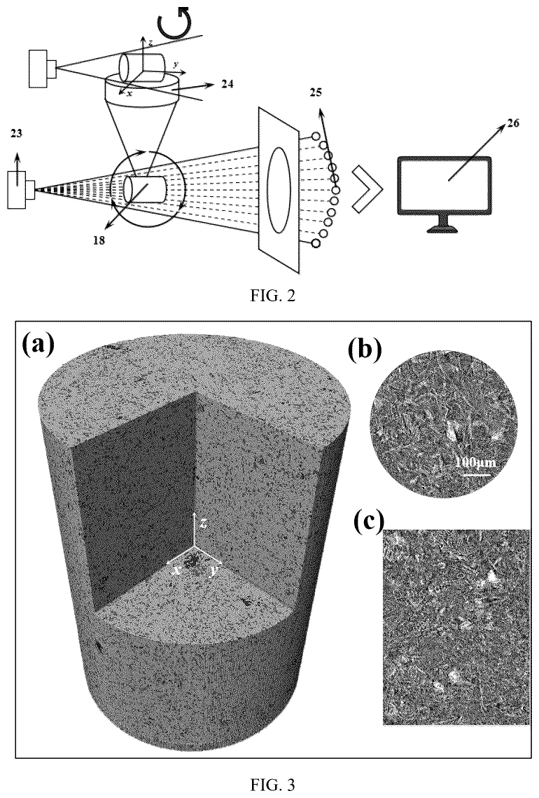

High-resolution imaging of the large-particle-size biochar 18 is performed by using the X-ray computed tomography technology to obtain the microstructural images of the large-particle-size biochar 18. As shown in FIG. 2, computed tomography utilizes a principle of X-ray penetration through an object. The large-particle-size biochar 18 is placed on a sample rotation stage 24, and an X-ray emitter 23 and an X-ray detector 25 rotate around the large-particle-size biochar 18 for scanning. By scanning the large-particle-size biochar 18 from multiple angles, the X-ray detector 25 collects electrical signals, which are then converted by a computer 26 into image data at several different angles. The acquired image data are presented in the form of grayscale images, where grayscale values correlate with material density, thereby providing a basis for subsequent image processing.

In step 3, preprocessing is performed on the grayscale images by using an Avizo™ software to obtain preprocessed images, and the preprocessing includes the following specific operations.

The acquired computed tomography images (i.e., the grayscale images) need to undergo preprocessing steps, including image screening, image type conversion, volume editing, image denoising, and contrast enhancement, to improve clarity and identifiability of the computed tomography images. The image denoising includes Gaussian filtering and image sharpening.

The image screening is performed according to the following steps. In Avizo™ 2023, after importing the computed tomography images at the different angles, a batch preliminary screening is first performed based on a signal-to-noise ratio <5, a dynamic range >2000, and a ring/streak-like anomaly coverage >5% of area in artifact detection. Images identified by this preliminary screening are designated as low-quality images, and remaining images of the computed tomography images are designated as valid images after the preliminary screening.

Subsequently, the low-quality images are manually reviewed for pore structure continuity and edge distortion. Images exhibiting non-connected pores or abnormal pore sizes are discarded as invalid data images, resulting in valid images after second screening. The valid images from the preliminary screening and the second screening are collectively referred to as qualified images. It should be noted that, the pore structure continuity refers to axial cross-section missing, the edge distortion refers to a curvature >0.5, the non-connected pores refer to those with a connectivity of 0, and the abnormal pore sizes refer to <2 micrometers (μm) noise or >1 millimeters (mm) fractures.

The qualified images are classified and stored according to resolution and completeness, with resolutions of 2 μm and 5 μm, and completeness categorized as complete and partial.

During the screening process, screening parameters and causes of anomalies are simultaneously recorded to ensure the reliability of the three-dimensional reconstruction and porosity analysis.

The qualified images obtained from the image screening step are respectively converted into 16-bit explicit images by converting the image type. The images are then cropped to remove the air portion scanned by the computed tomography device, retaining only the desired biochar region, thereby obtaining cropped images. Subsequently, volume editing is performed on the cropped images to obtain a cylindrical large-particle-size biochar 18. Image denoising and contrast enhancement are then applied to improve the clarity and identifiability of the images, resulting in multiple preprocessed images. These preprocessing steps ensure the accuracy of subsequent threshold segmentation and facilitate the precise identification of the pores, matrix, and minerals in the biochar.

In step 4, identification and threshold segmentation are performed on the multiple preprocessed images by using the Avizo™ software to obtain multiple threshold-segmented images. Then, the multiple threshold-segmented images are combined to obtain a three-dimensional reconstruction model of the biochar (i.e., the large-particle-size biochar 18).

The identification and the threshold are performed as the following steps.

In a first step, a region in each preprocessed image (corresponding to a slice of the biochar) with a lower brightness is determined as a pore region of the large-particle-size biochar 18. A first threshold range is selected, and the threshold segmentation is then performed to obtain a segmented pore region of the slice of the biochar. The first threshold range is 0 to 2500.

In a second step, a region in each preprocessed image with a higher brightness is then determined as a mineral region of the large-particle-size biochar 18. A second threshold range is selected, and the threshold segmentation is performed to obtain a segmented mineral region of the slice of the biochar. The second threshold range is 10,000 to 30,000.

In a third step, a region in each preprocessed image with a brightness between the brightness of the pore region and the brightness of the mineral region is then determined as a matrix region of the large-particle-size biochar 18. A second threshold range is selected, and the threshold segmentation is performed to obtain a segmented matrix region of the slice of the biochar. The second threshold range is 2,501 to 9,999.

The combination is performed as follows. Segmented pore regions, segmented mineral regions, and segmented matrix regions of slices of the biochar corresponding to the multiple threshold-segmented images are combined by using a region summation mathematical algorithm in the Avizo™ 2023 software, thereby obtaining the three-dimensional reconstruction model of the biochar.

After three-dimensional reconstruction, the obtained three-dimensional reconstruction model of the biochar is analyzed by using a layer analysis algorithm in the Avizo™ 2023 software to calculate a proportion of pores in each planar layer, thereby obtaining layer-by-layer porosity results. Based on the layer-by-layer porosity results, the porosity of the prepared large-particle-size biochar 18 is analyzed.

### Embodiment 3

A large-particle-size biochar 18 is prepared by using the microwave gasification system for large-particle-size biomass of the embodiment 1, which includes the following specific preparation steps.

Large-particle-size biomass used in this embodiment is large-particle-size tung wood biomass with a diameter of 2 cm, and knot positions of the tung wood need to be avoided during an experiment.

Prior to a gasification experiment, a certain amount of the large-particle-size tung wood biomass is weighed and placed into the quartz basket 15, and then the quartz basket 15 is placed on a left side of the quartz tube 14. After checking airtightness of the devices, a gas supply valve of the nitrogen supply device 2 is opened, and impurity gases are purged by using the second mass flow meter 6 at a flow rate of 100 milliliters per minute (mL·min⁻¹) for 30 minutes. The microwave generator 12 and the temperature-power controller 13 are configured. Specifically, on the temperature-power controller 13 of the microwave gasification furnace 27, a gasification temperature is set to a predetermined temperature of 800 °C, and a power is set to 600 watts (W). After reaching the predetermined temperature, supply of oxygen from the oxygen supply device 1 is controlled using the first mass flow meter 5 at a flow rate of 100 mL·min⁻¹. The quartz basket 15 is then pushed into a center position of the quartz tube 14. A gasification reaction is maintained for 25 minutes. After the gasification reaction is completed, the quartz basket 15 is pulled back to the left side of the quartz tube 14. The temperature-power controller 13 and the supply of the oxygen from the oxygen supply device 1 are shut off. When the quartz tube 14 is cooled to room temperature, the large-particle-size biochar 18 is obtained, designated as a first biochar. The obtained first biochar is pushed into the biochar collection tank 17 for collection, to be used in subsequent three-dimensional reconstruction steps for biochar.

### Embodiment 4

A large-particle-size biochar 18 is prepared by using the microwave gasification system for large-particle-size biomass of the embodiment 1, which includes the following specific preparation steps.

Large-particle-size biomass used in this embodiment is large-particle-size oak wood biomass with a diameter of 2 cm, and knot positions of the oak wood need to be avoided during an experiment.

Prior to a gasification experiment, a certain amount of the large-particle-size oak wood biomass is weighed and placed into the quartz basket 15, and then the quartz basket 15 is placed on a left side of the quartz tube 14. After checking airtightness of the devices, a gas supply valve of the nitrogen supply device 2 is opened, and impurity gases are purged using the second mass flow meter 6 at a flow rate of 100 mL·min⁻¹ for 30 minutes. The microwave generator 12 and the temperature-power controller 13 are configured. Specifically, on the temperature-power controller 13 of the microwave gasification furnace 27, a gasification temperature is set to a predetermined temperature of 800 °C, and a power is set to 600 W. After reaching the predetermined temperature, supply of oxygen from the oxygen supply device 1 is controlled using the first mass flow meter 5 at a flow rate of 100 mL·min⁻¹. The quartz basket 15 is then pushed into a center position of the quartz tube 14. A gasification reaction is maintained for 25 minutes. After the gasification reaction is completed, the quartz basket 15 is pulled back to the left side of the quartz tube 14. The temperature-power controller 13 and the supply of the oxygen from the oxygen supply device 1 are shut off. When the quartz tube 14 is cooled to room temperature, the large-particle-size biochar 18 is obtained, designated as a second biochar. The obtained second biochar is pushed into the biochar collection tank 17 for collection, to be used in subsequent three-dimensional reconstruction steps for biochar.

### Embodiment 5

A large-particle-size biochar 18 is prepared by using the microwave gasification system for large-particle-size biomass of the embodiment 1, which includes the following specific preparation steps.

Large-particle-size biomass used in this embodiment is large-particle-size pine wood biomass with a diameter of 2 cm, and knot positions of the pine wood need to be avoided during an experiment.

Prior to a gasification experiment, a certain amount of the large-particle-size pine wood biomass is weighed and placed into the quartz basket 15, and then the quartz basket 15 is placed on a left side of the quartz tube 14. After checking airtightness of the devices, a gas supply valve of the nitrogen supply device 2 is opened, and impurity gases are purged using the second mass flow meter 6 at a flow rate of 100 mL·min⁻¹ for 30 minutes. The microwave generator 12 and the temperature-power controller 13 are configured. Specifically, on the temperature-power controller 13 of the microwave gasification furnace 27, a gasification temperature is set to a predetermined temperature of 800 °C, and a power is set to 600 W. After reaching the predetermined temperature, supply of oxygen from the oxygen supply device 1 is controlled using the first mass flow meter 5 at a flow rate of 100 mL·min⁻¹. The quartz basket 15 is then pushed into a center position of the quartz tube 14. A gasification reaction is maintained for 25 minutes. After the gasification reaction is completed, the quartz basket 15 is pulled back to the left side of the quartz tube 14. The temperature-power controller 13 and the supply of the oxygen from the oxygen supply device 1 are shut off. When the quartz tube 14 is cooled to room temperature, the large-particle-size biochar 18 is obtained, designated as a third biochar. The obtained third biochar is pushed into the biochar collection tank 17 for collection, to be used in subsequent three-dimensional reconstruction steps for biochar.

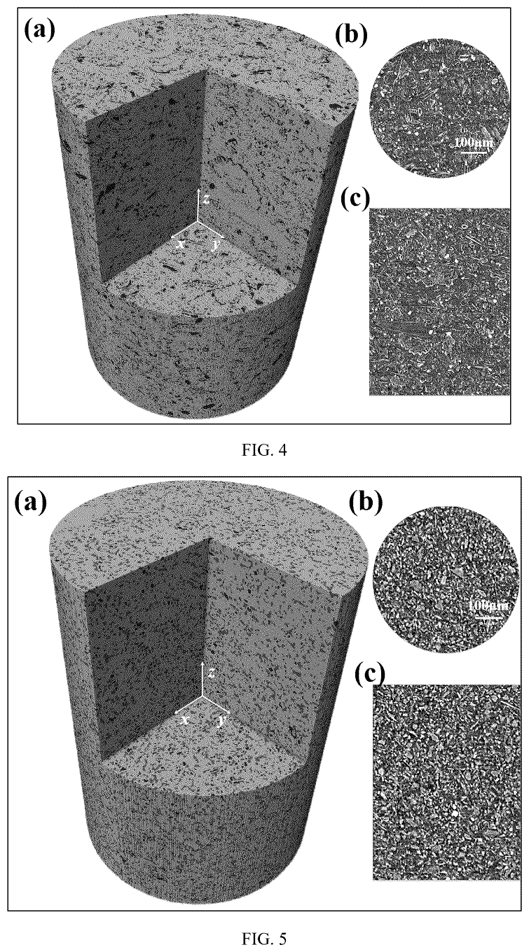

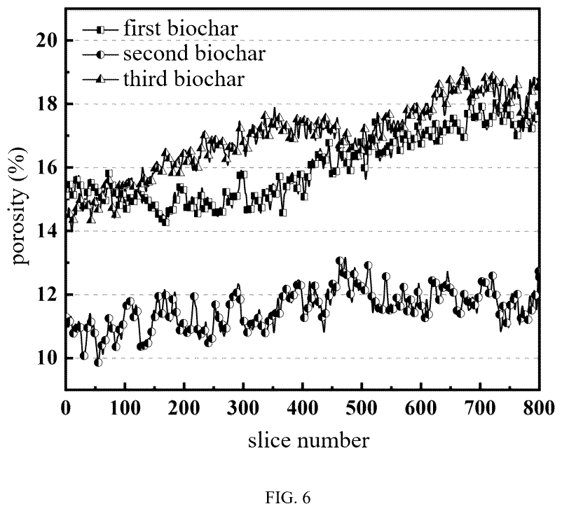

The large-particle-size biochars prepared in the embodiments 3 to 5 are subjected to three-dimensional reconstruction according to the method of the embodiment 2. As shown in FIGS. 3 to 5, they illustrate the three-dimensional reconstruction diagrams and grayscale cross-section images of the three different large-particle-size biochars, respectively. In practical operation, mineral regions are shown in red, pore regions are shown in blue, and matrix regions are shown in yellow. Subsequently, porosity analysis of biochar is performed. Using the layer analysis algorithm in the Avizo™ 2023 software, a proportion of pores in each planar layer is calculated, yielding layer-by-layer porosity results, as illustrated in FIG. 6. Specifically, the third biochar exhibits a highest porosity, while the second biochar shows a lowest porosity. The third biochar can subsequently be selected for further research in fields such as soil improvement, pollutant adsorption, catalytic tar cracking, and environmental remediation, and can be applied in practical industrial production.

To sum up, the disclosure integrates biomass microwave gasification, X-ray computed tomography, and image processing techniques to establish an innovative research method for biochar. A method for preparing biochar according to the disclosure can be applied in multiple fields, including environmental remediation, wastewater treatment, and soil improvement. Through computed tomography and image processing techniques, the disclosure accurately identifies and analyzes the pore structure and mineral distribution within biochar. The disclosure can advance biochar research and provide novel insights for subsequent technological development.

Obviously, the above embodiments are only some embodiments of the disclosure, rather than all embodiments of the disclosure. Based on the above embodiments in the disclosure, all other embodiments obtained by those skilled in the art without making any inventive effort fall within the scope of protection of the disclosure.

What is claimed is:

1. A microwave gasification system for large-particle-size biomass, comprising:
a microwave gasification device, configured to perform microwave gasification treatment on a large-particle-size biomass feedstock (16) to form a large-particle-size biochar (18), wherein a particle size of the large-particle-size biomass feedstock (16) is centimeter-scale;
an oxygen supply device (1), wherein an output end of the oxygen supply device (1) is connected to an input end of the microwave gasification device, and the oxygen supply device (1) is configured to supply oxygen for the microwave gasification treatment in the microwave gasification device;
a nitrogen supply device (2), wherein an output end of the nitrogen supply device (2) is connected to the input end of the microwave gasification device, and the nitrogen supply device (2) is configured to supply nitrogen as a protective gas for the microwave gasification treatment in the microwave gasification device;
a water vapor supply device, wherein an output end of the water vapor supply device is connected the input end of the microwave gasification device, and the water vapor supply device is configured to provide a gas motive force for conveying the large-particle-size biomass feedstock (16) to a reaction zone of the microwave gasification device; the water vapor supply device comprises a water supply device and a heat tracing tape (10), an output end of the water supply device is connected to the input end of the microwave gasification device through a delivery pipe to supply water, and the heat tracing tape (10) is wound around the delivery pipe and configured to heat the water in the delivery pipe to form water vapor serving as the gas motive force and entering the microwave gasification device;
a biochar collection device, wherein an input end of the biochar collection device is connected to a solid output end of the microwave gasification device, and the biochar collection device is configured to collect the large-particle-size biochar (18) produced by the microwave gasification treatment in the microwave gasification device;
a tar collection device (19), wherein an input end of the tar collection device (19) is connected to a gas output end of the microwave gasification device, and the tar collection device (19) is configured to receive gas generated from the microwave gasification treatment in the microwave gasification device and perform pretreatment on the gas to remove tar from the gas, thereby obtaining tar-removed gas;
a syngas purifier (21), wherein an input end of the syngas purifier (21) is connected to a gas output end of the tar collection device (19), and the syngas purifier (21) is configured to remove impurities and moisture from the tar-removed gas to form purified syngas; and
a syngas collection device, wherein an input end of the syngas collection device is connected to a gas output end of the syngas purifier (21), and the syngas collection device is configured to collect the purified syngas for combustion utilization;
wherein the microwave gasification device comprises:
a microwave gasification furnace;
a microwave generator (12), disposed in the microwave gasification furnace and configured to provide microwave irradiation;
a temperature-power controller (13), electrically connected to the microwave generator (12) and configured to control a reaction temperature and a power of the microwave irradiation provided by the microwave generator (12);
a quartz tube (14), horizontally disposed in the microwave gasification furnace and configured to define the reaction zone for the microwave gasification treatment in the microwave gasification device;
a quartz basket (15), disposed in the quartz tube (14) and configured to hold the large-particle-size biomass feedstock (16); and
a microwave thermocouple (11), horizontally disposed in the quartz tube (14) and configured to monitor in real time a temperature of a microwave gasification reaction in the microwave gasification furnace.

2. The microwave gasification system for large-particle-size biomass as claimed in claim 1, wherein a first pressure-reducing valve (3) is disposed between the output end of the oxygen supply device (1) and the input end of the microwave gasification device, and the first pressure-reducing valve (3) is configured to reduce a pressure of the oxygen;
wherein a second pressure-reducing valve (4) is disposed between the nitrogen supply device (2) and the input end of the microwave gasification device, and the second pressure-reducing valve (4) is configured to reduce a pressure of the nitrogen;
wherein a first mass flow meter (5) is disposed between the output end of the oxygen supply device (1) and an input end of the first pressure reducing valve (3), and the first mass flow meter (5) is configured to monitor a flow rate of the oxygen; and
wherein a second mass flow meter (6) is disposed between the output end of the nitrogen supply device (2) and an input end of the second pressure reducing valve (4), and the second mass flow meter (6) is configured to monitor a flow rate of the nitrogen.

3. The microwave gasification system for large-particle-size biomass as claimed in claim 1, wherein the tar collection device (19) is a gas scrubber containing isopropanol (20), and configured to remove the tar from the gas generated from the microwave gasification treatment in the microwave gasification device.

4. The large-particle-size biomass microwave gasification system as claimed in claim 1, wherein the syngas purifier (21) is packed with desiccant silica gel particles.

5. A biochar, prepared by the microwave gasification treatment using the microwave gasification system for large-particle-size biomass as claimed in claim 1.

6. An application of the biochar in preparation of a soil amendment material, a pollutant adsorption material, a catalytic tar cracking material, or an environmental remediation material, comprising:
determining a porosity of the biochar; and
selecting, based on the porosity of the biochar, a specific application for the biochar;
wherein the porosity of the biochar is determined by:
obtaining, by using X-ray computed tomography, microstructural images of the biochar as claimed in claim 5 to form grayscale images at different angles;
performing preprocessing on the grayscale images at the different angles by using an Avizo™ software to improve clarity and identifiability of the grayscale images, thereby obtaining a plurality of preprocessed images;
performing identification and threshold segmentation on the plurality of preprocessed images by using the Avizo™ software to obtain a plurality of threshold-segmented images;
combining the plurality of threshold-segmented images to obtain a three-dimensional reconstruction model of the biochar; and
performing porosity analysis on the three-dimensional reconstruction model of the biochar to obtain the porosity of the biochar.

7. The application of the biochar in preparation of the soil amendment material, the pollutant adsorption material, the catalytic tar cracking material, or the environmental remediation material as claimed in claim 6, wherein the preprocessing comprises image screening, image type conversion, volume editing, image denoising, and contrast enhancement; and
wherein the identification is performed by:
distinguishing, based on brightness in each of the plurality of preprocessed images, a pore region and a mineral region, wherein a region with a brightness between a brightness of the pore region and a brightness of the mineral region is a matrix region, thereby obtaining the pore region, the matrix region, and the mineral region of the biochar.

8. The application of the biochar in preparation of the soil amendment material, the pollutant adsorption material, the catalytic tar cracking material, or the environmental remediation material as claimed in claim 6, wherein the threshold segmentation is performed by:
performing the threshold segmentation on the pore region of the biochar based on a first threshold range to obtain a segmented pore region of a slice of the biochar, wherein the first threshold range is 0 to 2500;
performing the threshold segmentation on the mineral region of the biochar based on a second threshold range to obtain a segmented mineral region of the slice of the biomass, wherein the second threshold range is 10,000 to 30,000; and
performing threshold segmentation on the matrix region of the biochar based on a third threshold range to obtain a segmented matrix region of the slice of the biochar, wherein the third threshold range is 2501 to 9999.
